(19) United States
(12) Patent Application Publication
(10) Pub. No.: US 2009/0313454 A1
(43) Pub. Date: Dec. 17, 2009

(54) Multiprocessor System and Display Device Using the Same

(76) Inventor: Takashi Sasaki, Mie (JP)

Correspondence Address: HARNESS, DICKEY & PIERCE, P.L.C., P.O. BOX 8910, RESTON, VA, 20195, US

(21) Appl. No.: 12/085,998

(22) PCT Filed: Sep. 21, 2006
(86) PCT No.: PCT/JP2006/318695

§ 371 Date: Jun. 4, 2008

(30) Foreign Application Priority Data
Feb. 24, 2006 (JP) 2006 049365

(51) Int. Cl. G06F 15/76; G06F 9/06

(52) U.S. Cl. 712/31; 712/E09.003

(57) ABSTRACT

In a multiprocessor system (1), a processor (3) as a monitor monitors data read access performed by a processor (2) as a master to a memory (4) as a slave. The processor (3) acquires data outputted from the memory (4) when a data read-out command outputted from the processor (2) contains an address associated with the processor (3).

### TECHNICAL FIELD

The present invention relates to a multiprocessor system comprising plural processors.

### BACKGROUND ART

There have been known SPI (Serial Peripheral Interface) and I²C (Inter-Integrated Circuit) as a method for connecting on-board between processors such as a microcomputer, a microcontroller and the like and other ICs by using a serial interface. Examples of ICs encompass an EEPROM, a shift resistor, a display driver, an A/D converter, and the like. The SPI performs communication between one master and slave(s) regardless of whether the number of processors is one or more. In the I²C, however, in addition to the foregoing way using only one master, a multi-master function is available which performs communication between plural masters and slave(s).

FIG. 6 (a) shows an example in which two masters (MASTERs) including a processor, which is an ASIC, share an EEPROM, which is a slave (SLAVE), via the I²C. In this case, serial clocks outputted from the masters determine the timing of reading data from the slave and writing data to the slave.

FIG. 6 (b) shows an arrangement in which masters (MASTERs) including a processor, which is an ASIC, are connected respectively to EEPROMs, which are the different slaves (SLAVEs). This arrangement is feasible either for the SPI or the I²C.

Patent document 1 discloses a multiprocessor system in which plural multiprocessors share a memory.

FIG. 7 shows an arrangement of the multiprocessor system described in Patent document 1.

In FIG. 7, three processors 91 to 93 are connected to a shared memory 108 via a shared bus 112. A bus arbitration circuit 107b arbitrates so as to determine which one of the processors 91 to 93 performs read operation and write operation to the shared memory 108. The processor 91 is connected to a bus control circuit 104b and a local memory 101 via a local bus 102, and the bus control circuit 104b connects the local bus 102 to the shared bus 112. The processor 92 is connected to a bus control circuit 105b and a local memory 201 via a local bus 202, and the bus control circuit 105b connects the local bus 202 to the shared bus 112. The processor 93 is connected to a bus control circuit 106b and a local memory 301 via a local bus 302, and the bus control circuit 106b connects the local bus 302 to the shared bus 112.

In this arrangement, when the processors 91 to 93 request to read data having the same address in the shared memory 108, requests for the data having the same address will be inputted from the bus control circuits 104b, 105b, and 106b via a control line 110 to the bus arbitration circuit 107b. The bus arbitration circuit 107b accepts the read request from one of the processors according to a predetermined order of priority. Then, the bus arbitration circuit 107b performs the following control to the bus control circuits 104b, 105b, and 106b via a control line 111: connecting an address bus and a data bus of the processor to the shared bus 112; and connecting the data buses of the other processors to the shared bus 112. This allows the processors 91 to 93 to simultaneously read the data having the same address in the shared memory 108.

On the other hand, when the processors 91 to 93 request to read data having different addresses in the shared memory 108, requests for the data having different addresses will be inputted to the bus arbitration circuit 107b via the control line 110. The bus arbitration circuit 107b accepts the read request from one of the processors according to the predetermined order of priority. Then, the bus arbitration circuit 107b performs the following control to the bus control circuits 104b, 105b, and 106b via the control line 111: connecting the address bus and the data bus of the one of the processors to the shared bus 112; and making the other processors enter a wait state. This allows only one of the processors to read the data from the shared memory 108.

[Patent Document 1]

Japanese Unexamined Patent Application Publication, Tokukaihei, No. 11-102348 (published on Apr. 13, 1999)

### DISCLOSURE OF INVENTION

As is clear from the description for FIG. 6 (a), in the I²C, a collision occurs between masters for the access to a slave because the masters individually determine the timing of reading data from the slave and writing data to the slave. For this reason, data communication using plural masters needs to be designed in consideration of the collision between the masters. If sufficient measures against the collision are not taken, the communication may have an error.

As is clear from the description for FIG. 6 (b), when masters access to different memories, a collision between the masters will not occur, but the number of memories will increase. This results in an increase in cost.

Also, in order to allow each processor to access to a memory in an SPI comprising plural processors, the processor to be set as a master needs to be switched as needed in order to assign an access right to each of the processors.

Further, in the arrangement of Patent document 1, the bus arbitration circuit 107b is necessary in order to prevent a collision between the processors for the access to the shared memory 108. This causes a complicated system arrangement and an increase in cost.

In light of this, the following is important for a multiprocessor system: Plural processors reliably avoid a collision while having a simple arrangement, and the processors access to the minimum number of memories. Particularly when the plural processors use the same data, the processors' sharing the memory so as to share the same data will largely simplify the arrangement of the multiprocessor system.

The present invention has been made in view of the foregoing problems, and has an object for providing: a multiprocessor system capable of achieving an arrangement so as to reliably avoid a collision between processors for the access to a memory in a simple way and at low cost; and a display device provided with the multiprocessor system.

The multiprocessor system according to the present invention, in order to attain the object, has the following features: In a multiprocessor system comprising plural processors and a memory shared by the plural processors, only one of the processors is a master, the memory is a slave, and the processor other than the master is a monitor for monitoring data read access performed by the master to the memory and acquiring data associated with the processor from among data read by the master from the memory.

In the invention, the monitor monitors the data read access performed by the master to the memory. Then, the monitor acquires the data associated with the processor from among the data read by the master from the memory. Therefore, the monitor does not interfere with the access operation performed by the master. Even if plural monitors exist, the monitors do not interfere with each other. As a result, the collision between the processors can be avoided reliably. Furthermore, any additional arrangement for preventing the collision is not necessary.

Thus, the present invention gives an effect of providing a multiprocessor system capable of achieving an arrangement for reliably avoiding the collision between the processors for the access to the memory in a simple way and at low cost.

The display device according to the present invention, in order to attain the object, comprises the multiprocessor system. In the display device, each of the plural processors performs drive control to a separately assigned region on a display region based on the data read from the memory.

With the invention, in the display device, the same signal can mostly be used in the regions made by the division of the display region. Therefore, by making the data corresponding to the signal be stored in the memory of the multiprocessor system as shared data, the monitor have more opportunities to acquire the data read by the master. This gives an effect that the multiprocessor system works in the display device very effectively.

In addition, the more amount of data the processors share, the smaller the size of the memory can be, thereby achieving an advantage both in design space and cost.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 shows an embodiment of the present invention, and is a block diagram showing an arrangement of major parts in a multiprocessor system.

FIG. 2 is a block diagram showing a detailed arrangement of a monitor.

FIG. 3 shows an embodiment of the present invention, and is a block diagram showing an arrangement of an LCD (Liquid Crystal Display) device provided with the multiprocessor system described in FIG. 1.

FIG. 4 is a timing chart for signals outputted from the processors of the multiprocessor system in the LCD device described in FIG. 3.

FIG. 5 is an example of a map of a memory in the multiprocessor system in the LCD device described in FIG. 3.

FIG. 6 shows conventional arts, and (a) and (b) are block diagrams showing an example of an arrangement of a multiprocessor system.

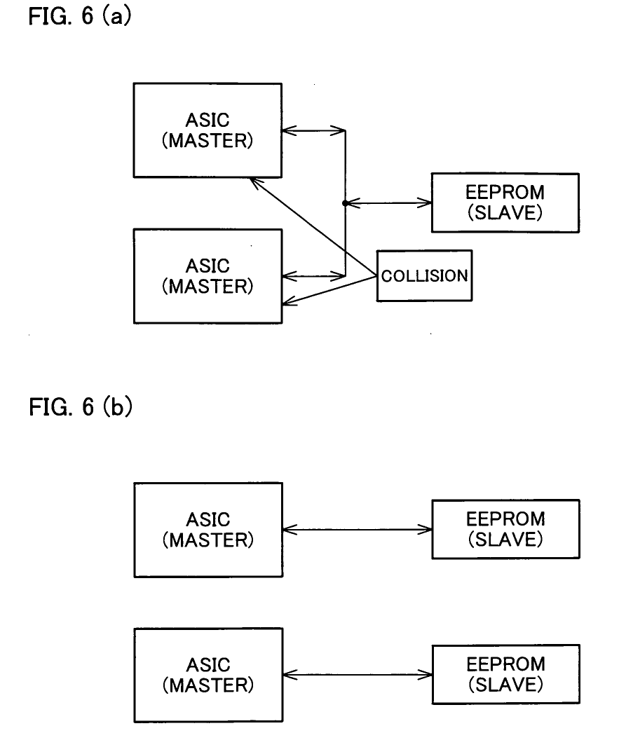

FIG. 7 shows a conventional art, and is a block diagram showing an example of another arrangement of a multiprocessor system.

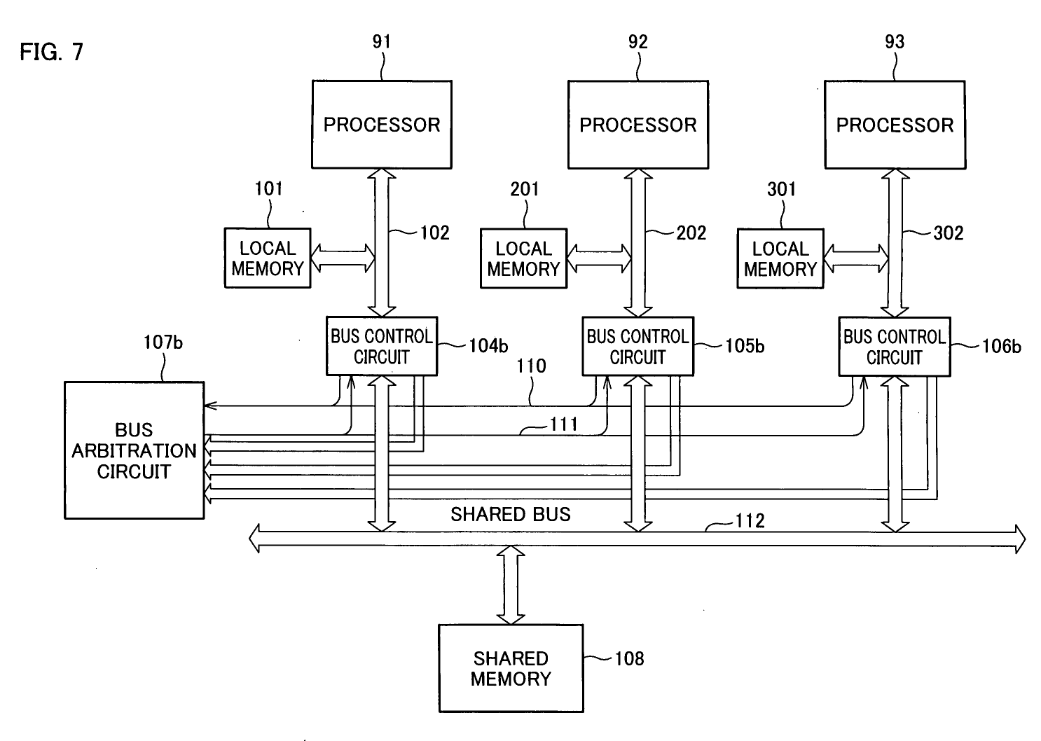

### DESCRIPTION FOR SYMBOLS

1 Multiprocessor system
2 Processor (MASTER)
3 Processor (MONITOR)
4 Memory (SLAVE)

### BEST MODE FOR CARRYING OUT THE INVENTION

The following explains an embodiment for further detailed description for the present invention. Note that the present invention is not limited to the embodiment.

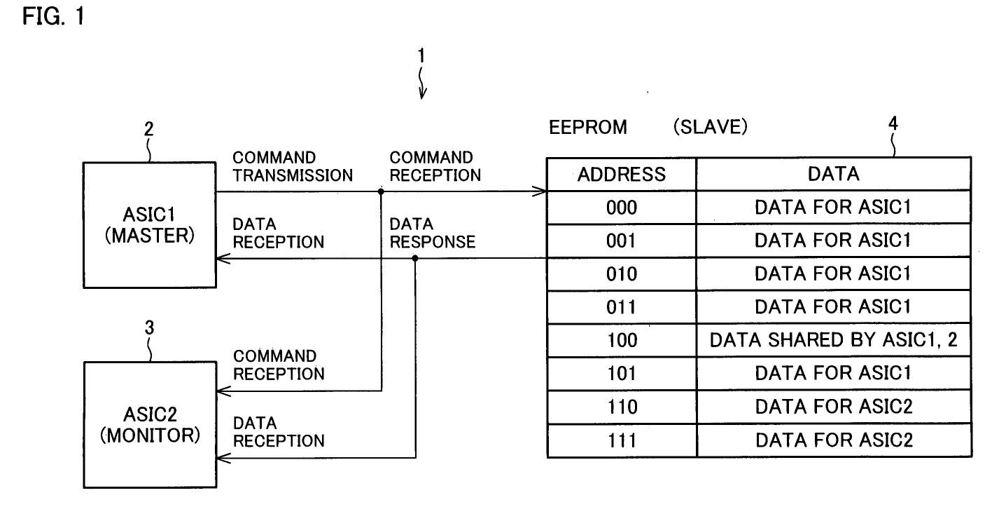

One embodiment of the present invention is described below with reference to FIGS. 1 to 5.

FIG. 1 shows an arrangement of a multiprocessor system 1 according to the present embodiment. The multiprocessor system 1 comprises processors 2 and 3, and a memory 4. Any interface such as an SPI, an I²C and the like can be adopted as an interface connecting between the processor 2, the processor 3, and the memory 4.

The processor 2 is a microprocessor or a microcontroller, which is an ASIC (described as ASIC1 in the figure), and is a master (MASTER) for controlling slave operation by transmitting a command to the slave in the multiprocessor system 1. In order to control the slave operation, the processor 2 outputs a clock for synchronizing transmitting and receiving operation for a command and data. The clock also determines the timing of receiving a command and data in a monitor described below. The processor 2 is the only master in the multiprocessor system 1.

The processor 3 is a microprocessor or a microcontroller, which is an ASIC (described as ASIC2 in the figure). The processor 3 is a monitor (MONITOR) for monitoring data read access performed by the processor 2 to the memory 4 in the multiprocessor system 1.

The memory 4 is a memory which stores data used by the processors 2 and 3, to which data is written by the processor 2, and which is shared by the processors 2 and 3. Here, the memory 4 is an EEPROM. Other than the EEPROM, the memory 4 may be other memories such as a flash memory or the like. In the multiprocessor system 1, the memory 4 is a slave (SLAVE) in which read operation and write operation are controlled by receiving a command from the processor 2, which is a master. FIG. 1 shows one example of stored data used by the processors 2 and 3. Addresses 000 to 011 and 101 store data for the processor 2 (described as “FOR ASIC1” in the figure), an address 100 stores data shared by the processor 2 and the processor 3 (described as “SHARED BY ASIC1, 2” in the figure), and addresses 110 and 111 store data for the processor 3 (described as “FOR ASIC2” in the figure).

An interface bus used for transmitting and receiving a command, data, and a clock may be respectively provided for the transmitting and receiving operation for each. However, the style of the interface bus may be set to suit the interface: For example, a style having an interface bus for transmitting and receiving both a command and data and an interface bus for transmitting and receiving a clock; and the like.

The number of processors may be three or more. In this case, all the processors other than the processor 2, which is the master, are the monitors. In the multiprocessor system 1 of the present embodiment, only one processor out of the plural processors is the master, and the processor to be the master is fixed.

Any peripheral IC may be connected as a slave, besides the memory 4. The peripheral IC may be an additional memory, a shift resistor, a display driver, an A/D converter or the like.

In the multiprocessor system 1 having the foregoing arrangement, the data read operation by the processor 2 to the memory 4 is performed as follows.

The processor 2 outputs a command indicating that the data read operation is to be performed on the interface bus, and transmits the command to the memory 4. An address storing data to be read is added to, for example, the latter part of the command, but the address information may be transmitted by the processor 2 after the memory 4 responds to the read request from the processor 2. The addresses transmitted by the processor 2 include not only the addresses for data used by the processor 2 itself, but also the addresses for data used by the processor 3. That is, in correspondence with FIG. 1, the processor 2 prepares commands to read data for all of the addresses 000 to 111.

When the memory 4 receives the command transmitted from the processor 2, the memory 4 outputs the data which has been stored in the designated address on the interface bus to respond to the processor 2.

The processor 2 acquires only data that the processor (i.e., the processor 2) uses from among data received from the memory 4, and ignores data that the processor does not use. The data that the processor uses here is, in correspondence with FIG. 1, the data having the addresses 000 to 101.

The processor 3 monitors the command outputted on the interface bus by the processor 2, and receives the command. Then, the processor 3 determines whether or not the command is a command to read data from the memory 4. When the command is a command to read data from the memory 4, the processor 3 determines whether or not the address of the data to be read matches the address of the data used by the processor (i.e., the processor 3). When the address of the data to be read matches the address of the data used by the processor, the processor 3 determines that the data is associated with the processor, and then receives and acquires the data outputted on the interface bus by the memory 4 in response to the command. The addresses of the data used by the processor here are, in correspondence with FIG. 1, the addresses 100, 110, and 111.

The processor 3 ignores the command in the following cases: the command outputted by the processor 2 on the interface bus is not a command to read data from the memory 4; and the address of the data to be read does not match the address of the data used by the processor. Therefore, in these cases, when the processor 3 receives the data outputted on the interface bus by the memory 4, the processor 3 does not acquire the data.

Next, the following describes a concrete example of an arrangement in light of an aspect of the processor 3 performing the foregoing operation as a monitor. The processor 2 as a master can be realized by normal master arrangements used for an interface such as an SPI, I²C and the like, so it will not be described here.

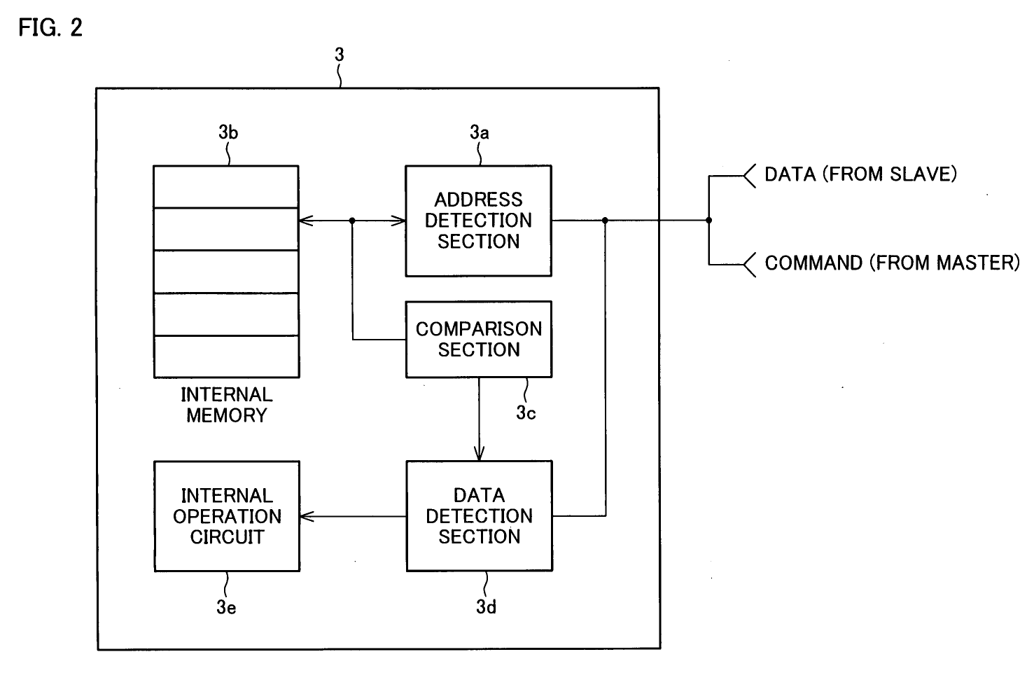

FIG. 2 shows an example of an arrangement of the processor 3 illustrated by using a functional block diagram as a monitor.

The processor 3 comprises an address detection section 3a, an internal memory 3b, a comparison section 3c, a data detection section 3d, and an internal operation circuit 3e.

The address detection section 3a determines whether or not a command outputted from the master (the processor 2) is a command to read data from the slave (the memory 4). When the address detection section 3a determines that the command is a command to read data, the address detection section 3a detects the address of the data to be read which is included in the command. The internal memory 3b is a memory storing an address of data used by the monitor (the processor 3) in advance. The comparison section 3c compares the address detected by the address detection section 3a with the address stored in the internal memory 3b to determine whether or not the detected address matches the stored address. Then, if the detected address matches the stored address, the comparison section 3c will transmit the address comparison result indicating that the addresses matched each other to the data detection section 3d; if the detected address does not match the stored address, the comparison section 3c will transmit the address comparison result indicating that the addresses did not match each other to the data detection section 3d.

The data detection section 3d receives the read data outputted from the slave (the memory 4), and determines whether or not the received data should be acquired into the internal operation circuit 3e based on the address comparison result inputted from the comparison section 3c. When the address comparison result indicating that the addresses matched each other is transmitted from the comparison section 3c, the received data will be acquired into the internal operation circuit 3e; when the address comparison result indicating that the addresses did not match each other is transmitted from the comparison section 3c, the received data will be discarded. The internal operation circuit 3e operates as a processor based on the acquired data.

Thus, in the present embodiment, the monitor monitors the data read access performed by the master to the memory. Also, the monitor acquires the data associated with the processor from among the data read by the master from the memory. Therefore, the monitor never interferes with the access operation performed by the master. Even if the plural monitors exist, the monitors do not interfere with each other. As a result, the collision between the processors can be avoided reliably. In addition, any additional arrangement for preventing the collision is not necessary.

Consequently, this provides a multiprocessor system capable of achieving an arrangement for reliably avoiding the collision between the processors for the access to the memory in a simple way and at low cost.

Next, the following describes an example of an LCD (Liquid Crystal Display) device provided with the multiprocessor system 1 according to the present embodiment.

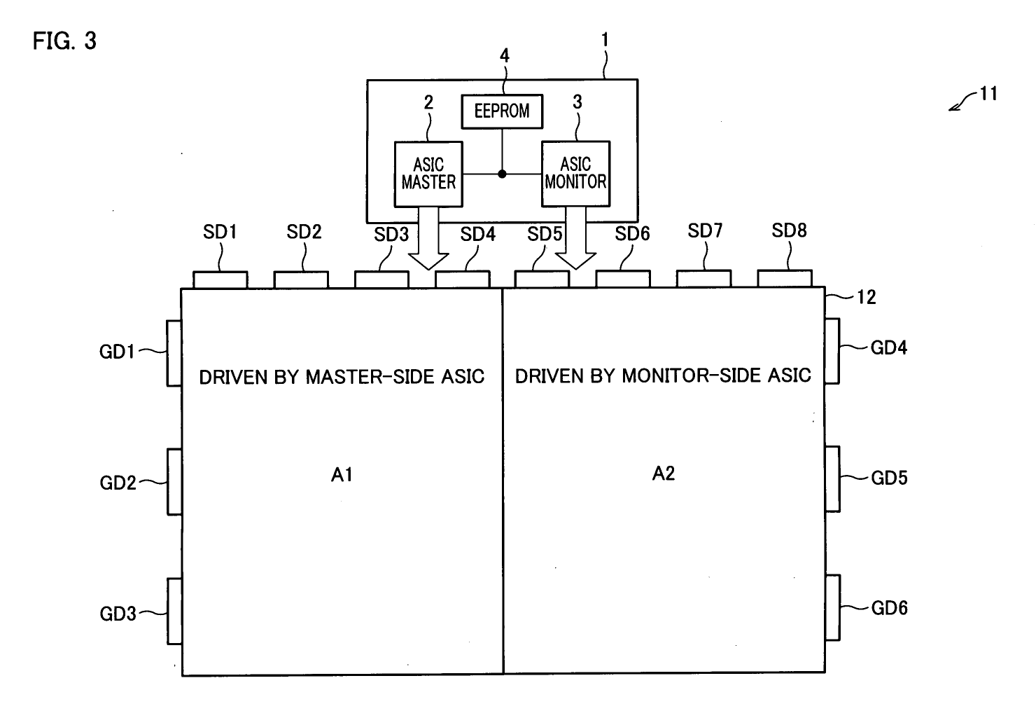

FIG. 3 shows an arrangement of an LCD device 11 provided with the multiprocessor system 1.

The LCD device 11 comprises an LCD panel 12. Drive control for a region A1 covering the left half of the display region on the LCD panel 12 is performed by the processor 2 of the multiprocessor system 1, and the drive control for a region A2 covering the right half of the display region on the LCD panel 12 is performed by the processor 3 of the multiprocessor system 1. Performing the drive control separately in the divided regions in this way is convenient for ensuring enough time to write display data to each pixel in an LCD device having high pixel count, that is to say high resolution.

The LCD panel 12 comprises source drivers SD1 to SD8 and gate drivers GD1 to GD6.

The source drivers SD1 to SD4 are cascade-connected, and the gate drivers GD1 to GD3 are also cascade-connected. The source drivers SD1 to SD4 and the gate drivers GD1 to GD3 are drive circuits for the region A1. The processor 2 provides a control signal such as a timing signal and the like to both the drive circuits.

The source drivers SD5 to SD8 are cascade-connected, and the gate drivers GD4 to GD6 are also cascade-connected. The source drivers SD5 to SD8 and the gate drivers GD4 to GD6 are drive circuits for the region A2. The processor 3 provides a control signal such as a timing signal and the like to both the drive circuits.

The timing signals include: a source start pulse signal SP, a latch strobe signal LS, and a gate clock signal GCK, each of which is associated with a horizontal timing used in a source driver SD; a gate start pulse signal GSP and a gate clock signal GSK, each of which is associated with a vertical timing used in a gate driver GD; and the like. Also, as the control signal, an image correction parameter may be included.

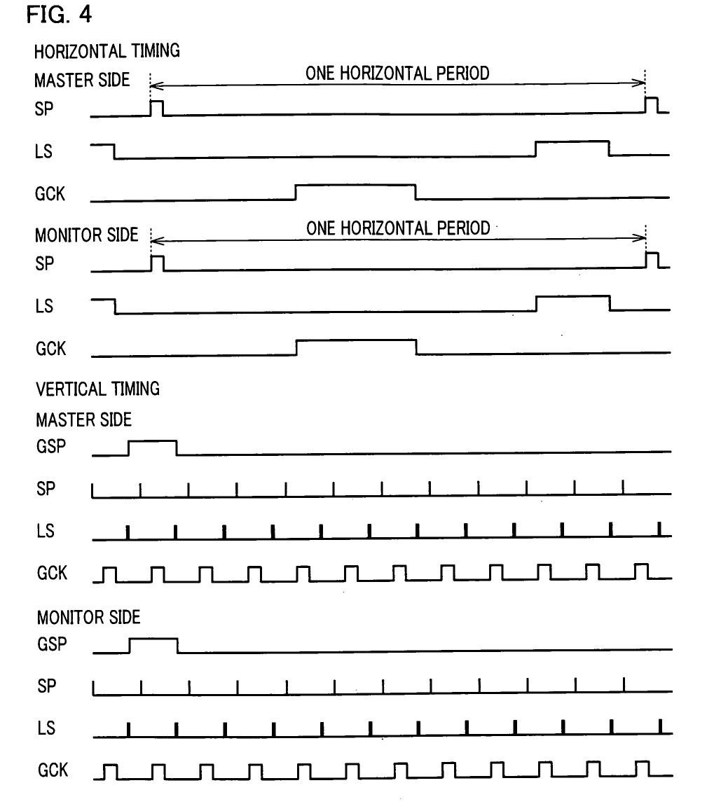

FIG. 4 shows a timing chart of these signals, which are mainly used herein. The signals are generated by the processors 2 and 3 based on the data acquired from the memory 4. In FIG. 4, the signals are indicated in a way that the signals outputted from the processor 2 (MASTER side) and the signals outputted from the processor 3 (MONITOR side) are separated. In FIG. 4, all the signals outputted from the processor 2 and all the signals outputted from the processor 3 have the same timing. When the plural processors generate and output the same signal in this way, the data for generating a signal may be read by the monitor from the memory 4 as shared data between the processors, and may be acquired by the master and the monitor simultaneously.

In the display device such as an LCD device and the like, even if the display region is divided, the same drive signal may mostly be used in each region. Therefore, the processors share more data which is to be stored in the memory 4. This means that the monitor has many opportunities to acquire the same data as the master acquires, thereby showing that the multiprocessor system 1 of the present embodiment effectively works as a system for performing the drive control for each of the regions made by the division of the display region. The number of regions made by the division of the display region may be three or more, and may be any number more than one. Also, the way of division is not limited to the foregoing way based on a parting line in column-wise on the display panel, but may be the way based on a parting line in row-wise. The multiprocessor system is provided with the processors at least equal in number to the number of regions made by the division. Each of the processors is individually assigned with a region on the display region for which the drive control should be performed.

The signals outputted by the processors 2 and 3 may include a signal for image corrections, and the memory 4 may store an image correction parameter. The image correction parameter is rarely different between the regions made by the division of the display region, and can mostly be used as a common parameter. Therefore, the multiprocessor system 1 of the present embodiment is also effective to image corrections.

Thus, the more amount of data the processors share, the smaller the size of the memory can be, thereby achieving an advantage both in design space and cost.

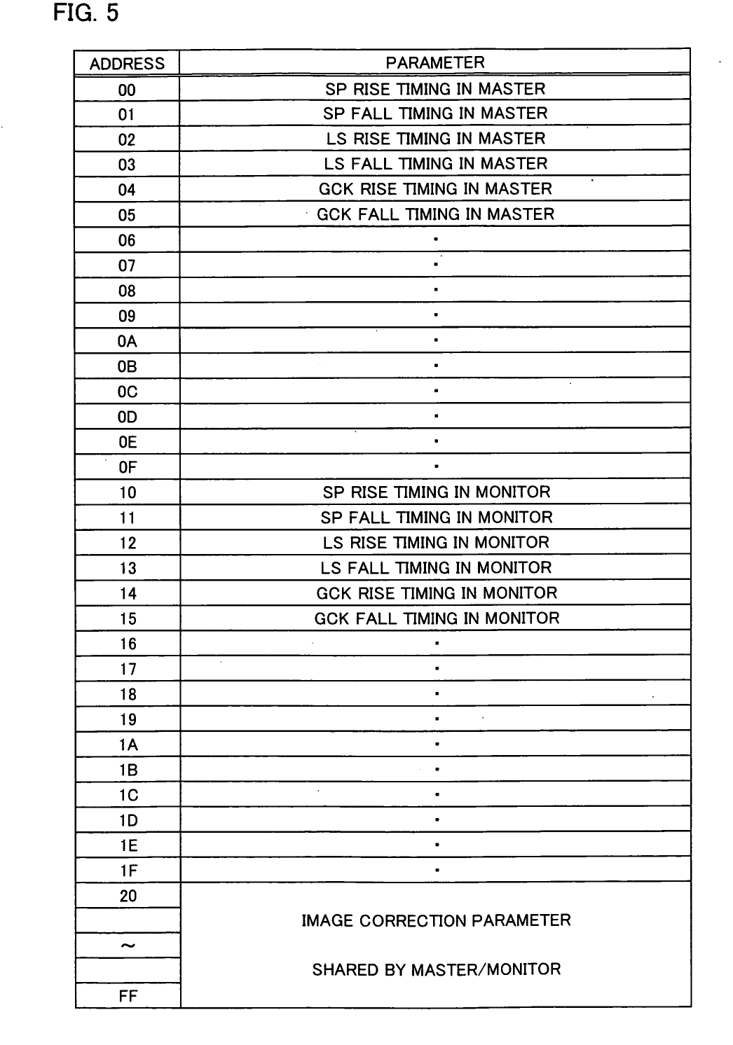

Further, when the timing of the signals such as shown in FIG. 4 is different between the signals outputted from the processor 2 and the signals outputted from the processor 3, the data corresponding to the signal may be stored in different addresses on the memory 4. The map of the memory 4 storing such data is shown in FIG. 5. In this map, data for the master is stored in addresses 00 to 00, and data for the monitor is stored in addresses 10 to 1F. The image correction parameter is stored for addresses 20 to FF as shared data because the image correction parameter can be shared by the master and the monitor.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The invention is useful for LCD (Liquid Crystal Display) devices.

1. A multiprocessor system comprising plural processors and a memory shared by the plural processors,
wherein only one of the processors is a master,
wherein the memory is a slave, and
wherein the processor other than the master is a monitor for monitoring data read access performed by the master to the memory and acquiring data associated with the processor from among data read by the master from the memory.

2. A display device comprising the multiprocessor system as set forth in claim 1, wherein each of the plural processors performs drive control to a separately assigned region on a display region based on the data read from the memory.
